(19) United States
(12) Patent Application Publication
(10) Pub. No.: US 2024/0225382 A1
(43) Pub. Date: Jul. 11, 2024

(54) HANDHELD CLEANING TOOL

(71) Applicant: Unger Marketing International, LLC, Bridgeport, CT (US)

(72) Inventors: William Harrington, Newtown, CT (US); Brandon M. Temple, Stamford, CT (US)

(73) Assignee: Unger Marketing International, LLC, Bridgeport, CT (US)

(21) Appl. No.: 18/407,838

(22) Filed: Jan. 9, 2024

Related U.S. Application Data
(60) Provisional application No. 63/479,291, filed on Jan. 10, 2023.

(51) Int. Cl. A47L 1/08; A47L 13/16; A47L 13/26; B25G 3/38

(52) U.S. Cl. CPC A47L 1/08; A47L 13/16; A47L 13/26; B25G 3/38

(57) ABSTRACT

A cleaning device includes a handle having a longitudinal axis, a cleaning element movably coupled to the handle, and a flexible conduit fluidly connectable to the cleaning element. The flexible conduit is positionable within an interior of the handle. The cleaning element is movable relative to the handle about a first axis and a second axis when the flexible conduit is fluidly coupled to the cleaning element. The first axis and the second axis are arranged at an angle relative to the longitudinal axis.

### CROSS REFERENCE TO RELATED APPLICATIONS

This application claims the benefit of U.S. Provisional Application No. 63/479,291, filed on Jan. 10, 2023, which is hereby incorporated by reference in its entirety.

### BACKGROUND

Exemplary embodiments disclosed herein pertain to the art of portable cleaning devices.

Many types of cleaning tools and devices are available in the consumer market today for the purpose of cleaning surfaces such as windows and other surfaces commonly found in homes and offices. Cleaning tools include sponges, brushes, scrubbing pads, window cleaning squeegees and paper towels.

### BRIEF DESCRIPTION

According to an embodiment, a cleaning device includes a handle having a longitudinal axis, a cleaning element movably coupled to the handle, and a flexible conduit fluidly connectable to the cleaning element. The flexible conduit is positionable within an interior of the handle. The cleaning element is movable relative to the handle about a first axis and a second axis when the flexible conduit is fluidly coupled to the cleaning element. The first axis and the second axis are arranged at an angle relative to the longitudinal axis.

In addition to one or more of the features described above, or as an alternative, in further embodiments an orientation of the cleaning element remains constant relative to the longitudinal axis as the cleaning element rotates about the first axis.

In addition to one or more of the features described above, or as an alternative, in further embodiments the second axis is orthogonal to the first axis.

In addition to one or more of the features described above, or as an alternative, in further embodiments a mounting assembly couples the cleaning element to the handle.

In addition to one or more of the features described above, or as an alternative, in further embodiments the mounting assembly includes a mounting bracket and an adapter connected to the mounting bracket. The mounting bracket is rotatable relative to the adapter about the first axis.

In addition to one or more of the features described above, or as an alternative, in further embodiments at least one of the mounting bracket and the adapter has a clevis-type configuration.

In addition to one or more of the features described above, or as an alternative, in further embodiments the adapter is positionable at a plurality of positions relative to the handle. The adapter is rotatable relative to the handle about the second axis.

In addition to one or more of the features described above, or as an alternative, in further embodiments the cleaning element includes a locking mechanism operable to retain the adapter in one of the plurality of positions.

In addition to one or more of the features described above, or as an alternative, in further embodiments the locking mechanism includes an engagement mechanism movable between an unlocked position and a locked position. The adapter is movable between the plurality of positions when the engagement mechanism is in the unlocked position and the adapter is restricted from movement between the plurality of positions when the engagement mechanism is in the locked position.

In addition to one or more of the features described above, or as an alternative, in further embodiments the adapter includes a plurality of radially spaced openings. In the locked position, a portion of the engagement mechanism is positionable within one of the plurality of radially spaced openings.

In addition to one or more of the features described above, or as an alternative, in further embodiments the cleaning element includes a body having a front lateral edge and a bottom surface and an internal cavity arranged adjacent to the front lateral edge. The flexible conduit is fluidly coupled to the internal cavity.

In addition to one or more of the features described above, or as an alternative, in further embodiments the internal cavity extends forward of the bottom surface.

In addition to one or more of the features described above, or as an alternative, in further embodiments one or more ports are formed on a bottom of the internal cavity.

In addition to one or more of the features described above, or as an alternative, in further embodiments the cleaning device includes a fluid source fluidly connected to a flexible conduit.

In addition to one or more of the features described above, or as an alternative, in further embodiments the cleaning device includes a pump operable to move fluid from the fluid source to the internal cavity.

In addition to one or more of the features described above, or as an alternative, in further embodiments the cleaning element includes a pad overlapping a bottom surface of the cleaning element.

In addition to one or more of the features described above, or as an alternative, in further embodiments the pad is configured to wrap about at least one side of the cleaning element.

In addition to one or more of the features described above, or as an alternative, in further embodiments the cleaning element includes a coupling mechanism and the pad includes a member removably connectable to the coupling mechanism.

According to an embodiment, cleaning device includes a cleaning element having a body with a front lateral edge and an internal cavity arranged adjacent to the front lateral edge and a handle having a longitudinal axis movably coupled to the cleaning element by a mounting assembly. The mounting assembly having a mounting bracket and an adapter connected to the mounting bracket and the adapter being positionable at a plurality of positions relative to the handle. The cleaning device also includes a locking mechanism movable between an unlocked position and a locked position, and operable to retain the adapter in one of the plurality of positions, a flexible conduit fluidly connected to a fluid source and the internal cavity, the flexible conduit being positionable within an interior of the handle, and a pump operable to move fluid from the fluid source to the internal cavity. The cleaning element is movable relative to the handle about a first axis and a second axis orthogonal to the first axis, both the first axis and the second axis being arranged at an angle relative to the longitudinal axis. An orientation of the cleaning element remains constant relative to the longitudinal axis as the cleaning element rotates about the first axis. The adapter is movable between the plurality of positions when the locking mechanism is in the unlocked position, and the adapter is restricted from moving between the plurality of positions when the locking mechanism is in the locked position.

### BRIEF DESCRIPTION OF THE DRAWINGS

The following descriptions should not be considered limiting in any way. With reference to the accompanying drawings, like elements are numbered alike:

FIG. 1 is a perspective view of a cleaning device according to an embodiment;

FIG. 2 is a side view of the cleaning device of FIG. 1 according to an embodiment;

FIG. 3 is a cross-sectional view of the cleaning device of FIG. 1 taken along line 3-3 according to an embodiment;

FIG. 4 is a side view of the handle of the cleaning device of FIG. 1 according to an embodiment;

FIG. 5 is a perspective view of the handle of FIG. 4 according to an embodiment;

FIG. 6 is a top perspective view of the cleaning element of a cleaning device according to an embodiment;

FIG. 7 is a bottom perspective view of the cleaning element of FIG. 6 according to an embodiment;

FIG. 8 is a cross-sectional view of the cleaning element of FIG. 6 taken along line 8-8 according to an embodiment;

FIG. 9 is a top perspective view of a cleaning element including a cleaning pad according to an embodiment;

FIG. 10 is a side perspective view of the cleaning element of FIG. 9 according to an embodiment; and

FIG. 11 is a top perspective view of a cleaning element including a mounting assembly according to an embodiment.

### DETAILED DESCRIPTION

A detailed description of one or more embodiments of the disclosed apparatus and method are presented herein by way of exemplification and not limitation with reference to the Figures.

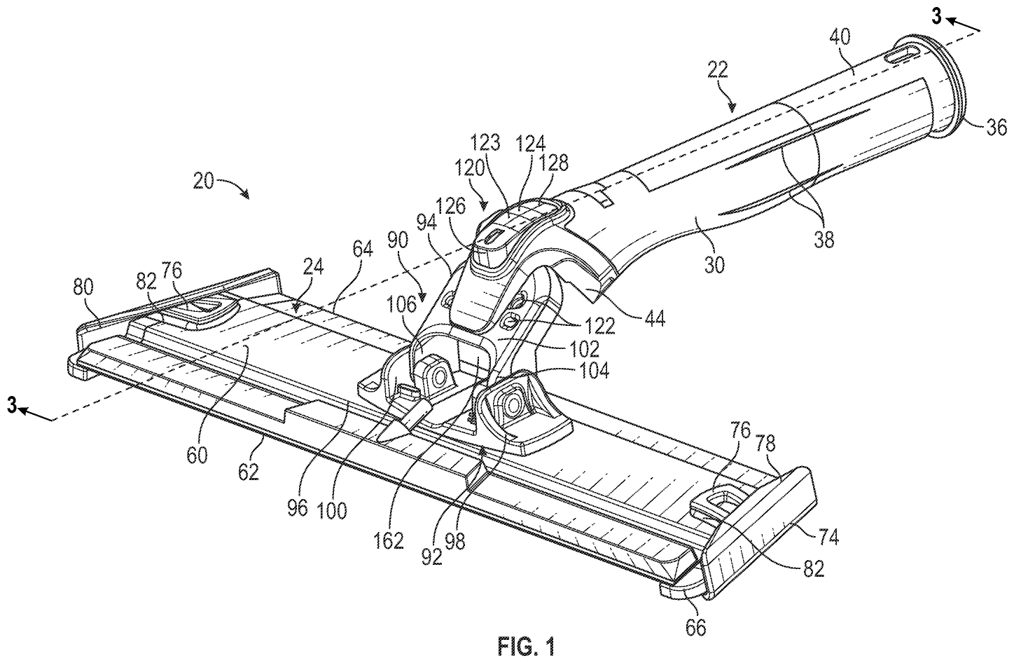

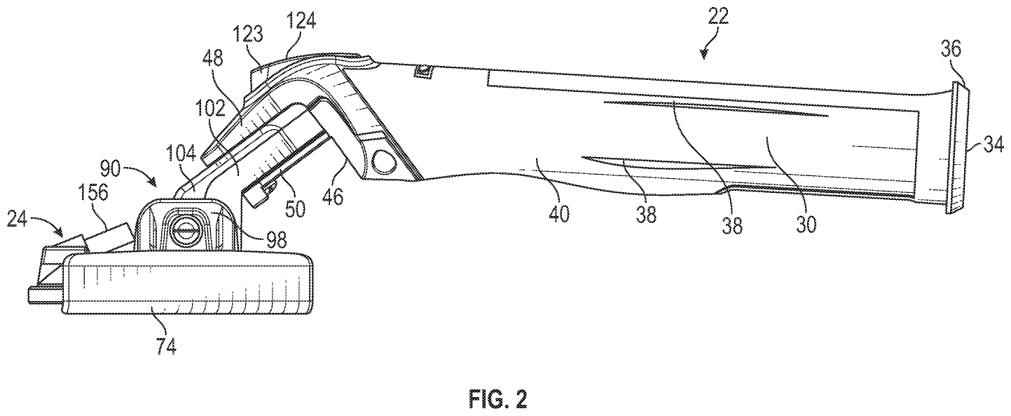

With reference now to FIGS. 1-3, an embodiment of a cleaning device according to an embodiment is illustrated at 20. The cleaning device 20 includes a handle 22 and a cleaning head or cleaning element 24 connected to the handle 22. The handle 22 includes an elongated handle body 30. Although the elongated handle body 30 is illustrated as being generally cylindrical in shape, embodiments where the handle body 30 has another shape are also contemplated herein. Furthermore, the outer diameter of the handle body 30 may be substantially uniform or may vary over the axial length of the handle body 30.

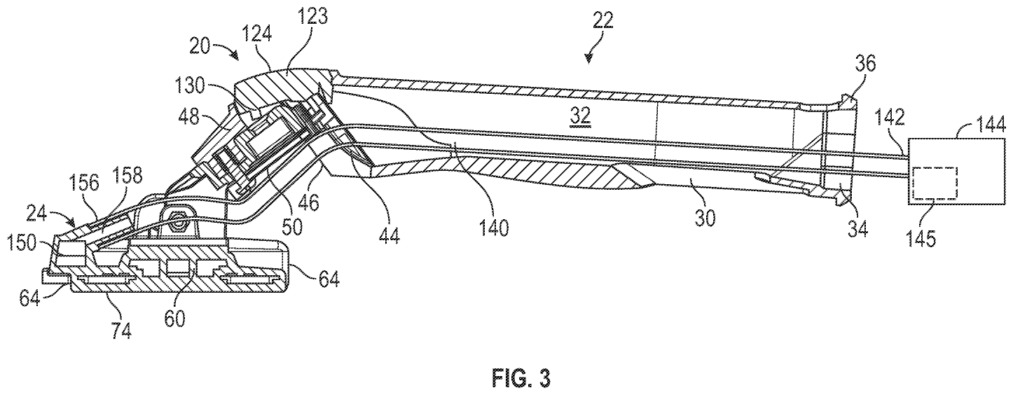

As best shown in FIG. 3, at least a portion of the handle body 30 has a substantially hollow interior 32. The hollow interior 32 may extend over only part, or alternatively, over the substantial entirety of the axial length of the handle body 30. In an embodiment, an opening 34 may be formed at a first end 36 of the handle body 30, the opening 34 being arranged in communication with the hollow interior 32. In an embodiment, the opening 34 may be sized to receive the end of a pole or other component (not shown) therein to allow for use of the cleaning device 20 in an extended configuration. To removably mount the cleaning device 20 to the end of the pole, the handle 22 may include at least a portion of a coupling mechanism (not shown). For example, a plurality of threads may be formed at an interior surface of the handle 22 and configured to mate with a corresponding plurality of threads (not shown) formed about a portion of the pole receivable within the opening 34; however, other suitable coupling mechanisms such as a snap-fit connection for example, are also contemplated herein.

One or more gripping features 38 may be formed at the outer surface 40 of the handle body 30. These gripping features 38 may be strategically positioned and designed to facilitate a user's grasp about the handle body 30. For example, the gripping feature 38 may include at least one elongate rib extending generally parallel to the longitudinal axis X of the handle body 30. In the illustrated non-limiting embodiment, a plurality of elongate ribs 38 are spaced about a periphery of the outer surface 40 of the handle body 30. It should be appreciated that the gripping features 38 illustrated and described herein are intended as an example only and that a gripping feature having any suitable configuration is within the scope of the disclosure. For example the gripping features 38 may be various shape, texture, and material configurations, although not limited thereto, to facilitate a user's grasp of the handle body 30 and/or provide varying degrees of ergonomic support. Furthermore, embodiments where the handle body 30 does not include any gripping features are also within the scope of the disclosure.

A connector portion 42 may be arranged at a second end 44 of the handle body 30, opposite the first end 36. In the illustrated non-limiting embodiment, the connector portion 42 is integrally formed with the handle body 30; however, embodiments where the connector portion is removably connectable to the handle body 30 are also within the scope of the disclosure. In an embodiment, both the connector portion 42 and the handle body 30 are formed from a first material, such as a plastic material. Further, at least a portion of the exterior surface 40 of the handle body 30 may be over molded with a second material, different or identical to the first material, such as to form the one or more gripping features 38. However, it is understood that each of the connector portion 42, the handle body 30, the exterior surface 40, and the gripping features 38 may be made of the same or different materials.

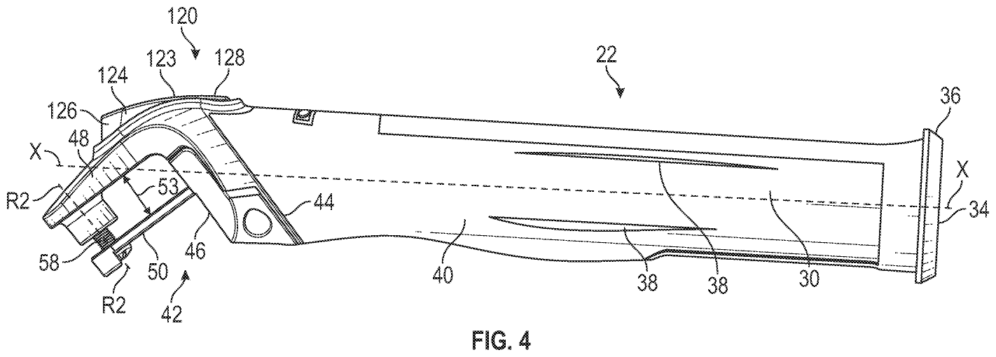

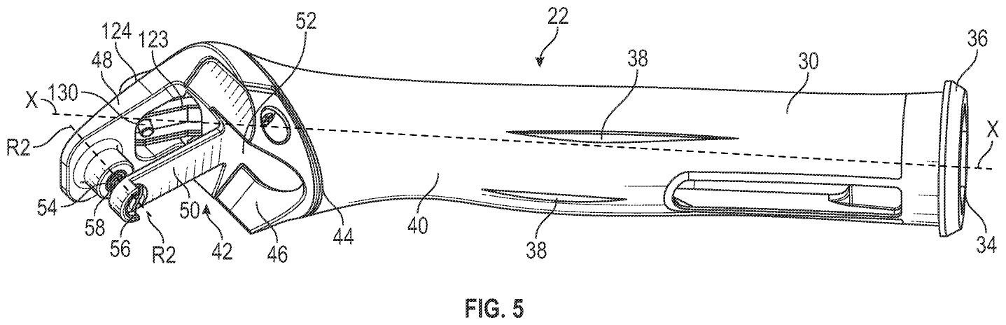

The connector portion 42 is best shown in FIGS. 4 and 5. As shown, the connector portion 42 generally includes a rear wall 46 overlapping the second end 44 and arranged at an angle to the longitudinal axis X of the handle body 30. An upper wall 48 protrudes from the rear wall 46 extending in a direction away from the handle body 30. The upper wall 48 may be positioned at or adjacent to an edge, for example the upper edge, of the rear wall 36. In the illustrated non-limiting embodiment, the upper wall 48 is arranged generally perpendicularly or orthogonally to the rear wall 46, such that the longitudinal axis X of the handle body 30 intersects both the rear wall 46 and the upper wall 48 of the connector portion 42.

In an embodiment, a lower wall 50 also extends from the rear wall 46. The lower wall 50 may be, but need not be, oriented generally parallel to the upper wall 48 as shown. In the illustrated non-limiting embodiment, the lower wall 50 is movably coupled relative to the rear wall 46. For example, as best shown in FIG. 5, a portion of the lower wall 50 may be engaged with a slot 52 formed in the rear wall 46 such that the lower wall 50 is configured to translate or slide relative thereto. A clearance 53 (see FIG. 4) is defined between the upper wall 48 and the lower wall 50 and in embodiments where the lower wall is movable, the resulting clearance 53 (see FIG. 4) is adjustable. The clearance 53 (see FIG. 4) may be adjusted continuously or stepwise. Although the movable lower wall 50 is illustrated as being separable and/or removable from the rear wall 46 or slot 52, embodiments where the lower wall 50 cannot be separated or removed from the rear wall 46 or slot 52 are also contemplated herein.

With continued reference to FIGS. 4 and 5, both the upper wall 48 and the lower wall 50 include an opening 54, 56 for receiving a fastener 58 therein. These openings 54, 56 are coaxial and may be located near the distal end of each wall 48, 50, respectively. In the illustrated non-limiting embodiment, the opening 56 formed in the lower wall 50 is a through opening; however, the openings 54, 56 formed in the upper wall 48 and the lower wall 50 respectively may, but need not, extend through the entire thickness of the respective upper wall 48 or lower wall 50.

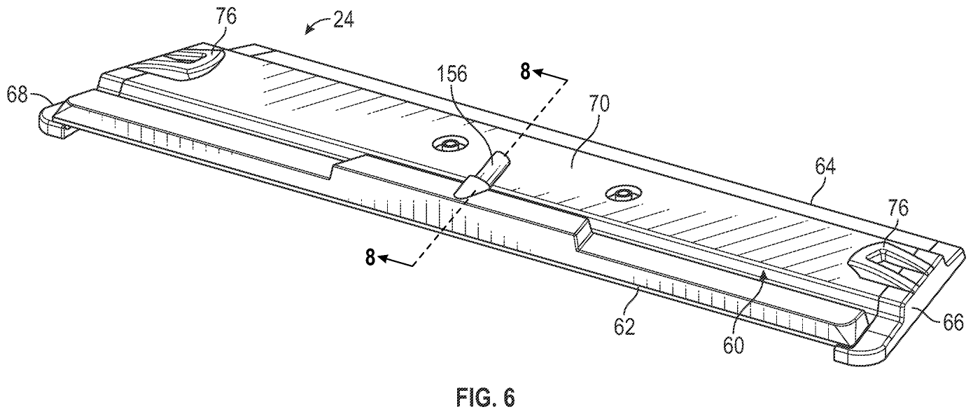

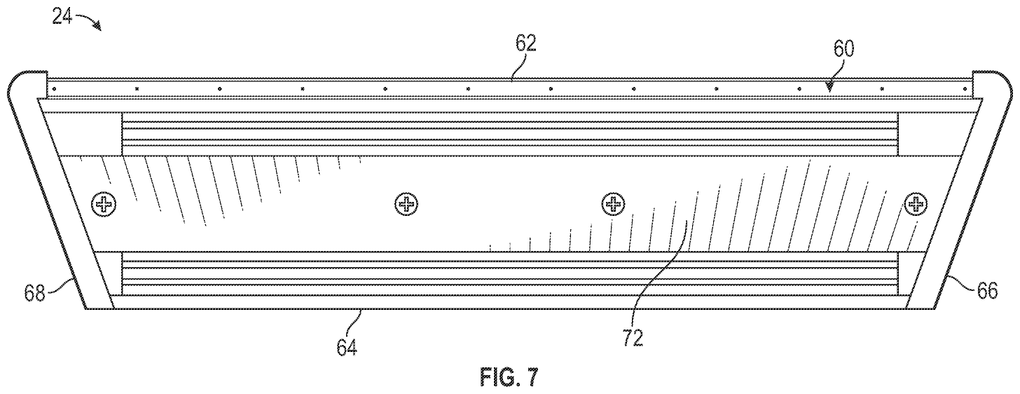

With continued reference to FIGS. 1-3 and further reference to FIGS. 6-11, in an embodiment, the cleaning element 24 of the cleaning device 20 has a body 60 formed from a generally rectangular plate. As shown, the body 60 has a front or first lateral edge 62, a rear or second lateral edge 64, and two sides 66, 68 extending between the first and second lateral edges 62, 64. As will be described in more detail below, a first surface 70 of the body 60 may be connectable to the handle 22 and a second surface 72, opposite the first surface 70, of the body 60. The second surface 72 may be configured to contact or face a surface to be cleaned. The second surface 72 may be substantially smooth, or alternatively, may have one or more ridges protruding therefrom or grooves formed therein.

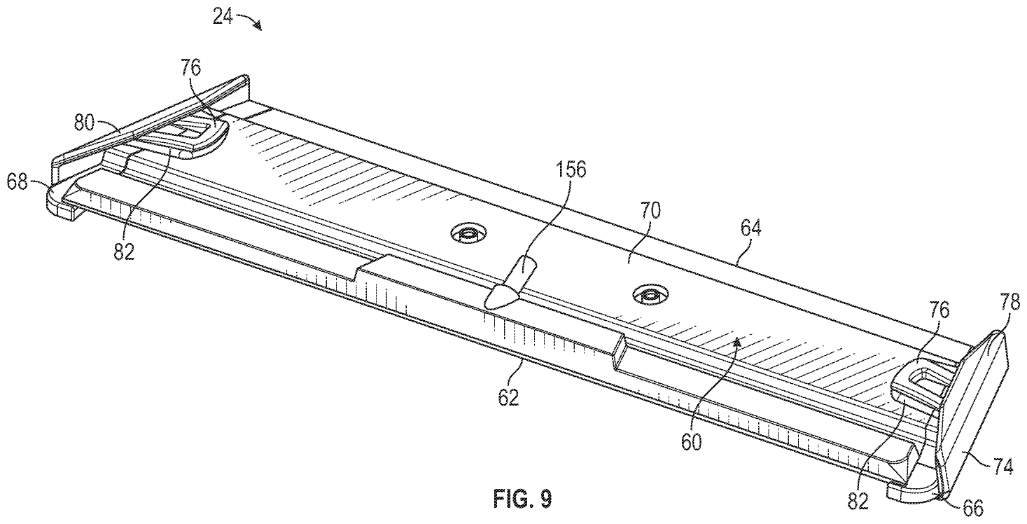

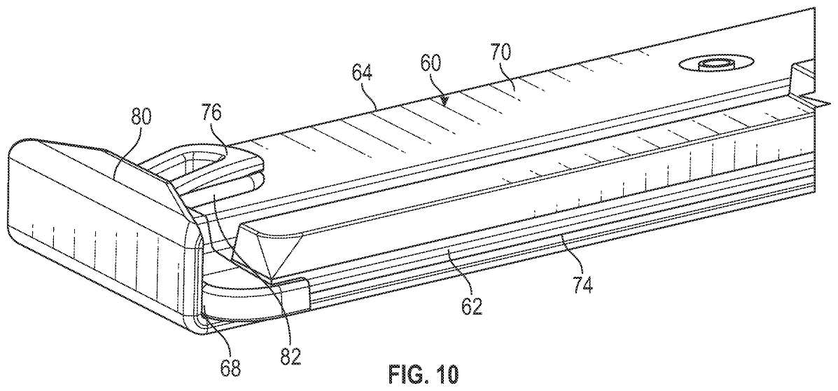

A reusable or disposable cover or pad 74 may be permanently or removably connected to the body 60. The cover or pad 74 may include a cleaning region formed from any suitable moisture absorbing and/or non-abrasive material, such as cotton, microfiber, or a woven material. As best shown in FIGS. 9 and 10, the pad 74 may be positioned in an overlapping arrangement with the second surface 72 of the body 60 such that a force may be transmitted from the body 60 to a surface to be cleaned, via the cleaning region of the pad 74. In an embodiment, the body 60 of the cleaning element 24 includes at least one coupling mechanism, such as a hook, indented clasp, or clip 76 for example, arranged at or adjacent to the first surface 70 of the body 60. In the illustrated non-limiting embodiment, the body 60 includes a first clip 76 arranged adjacent to the first side 66 of the body 60 and a second clip 76 arranged adjacent to the second side 68 of the body 60. However, embodiments including only a single coupling mechanism, or alternatively, more than two coupling mechanisms are also contemplated herein. Furthermore, it should be understood that the coupling mechanism may be located at any suitable position relative to the body 60, for example at or adjacent to the first and second lateral edges 62, 64. It is further contemplated that the cleaning device may have no clips 76 and that the pad 74 may be connected to the body 60 by an adhesive, hook and loop (e.g., Velcro), or by the ridges, protrusions, or groves on the second surface 72, although not limited thereto.

As shown, the pad 74 may have a shape or contour similar to the second surface 72 of the body 60. Further, an end of the pad 74 may be configured to wrap about at least one side and/or at least one lateral edge of the body 60. For example, a first end 78 of the pad 74 may wrap about the first side 66 of the body 60 and a second end 80 of the pad 74 may wrap about the second side 68 the body 60. In an embodiment, the pad 74 includes a loop or other member 82 connectable to the clip 76. As shown, a first loop 82 arranged at the first end 78 of the pad 74 may be configured to wrap about the first clip 76 and a second loop 82 arranged at a second, opposite end 80 of the pad 74 may be configured to wrap about the second clip 76, thereby limiting movement of the pad 74 relative to the body 60. In other embodiments, a portion of the pad 74 may be insertable into a gap between the coupling mechanism or clip 76 and the body 60 to affix the pad 74 to the body 60.

Alternatively, or in addition to, the at least one coupling mechanism arranged at or adjacent to the first surface 70 of the body 60, a fastener or other coupling mechanism, such as a portion of a hook and loop fastener for example, may be arranged at or adjacent to the second surface 72 of the body 60. In such embodiments, the pad 74 may include a corresponding portion of the coupling mechanism or fastener such that the pad 74 may be connectable directly to the second surface 72 of the body 60.

The cleaning element 24 may be connectable to the handle 22 via a mounting assembly 90. In the illustrated non-limiting embodiment, when connected, the cleaning element 24 may be movable relative to the handle 22 in at least a first direction. For example, the cleaning element 24 may be rotatable relative to the handle 22 about an axis R1. In the illustrated non-limiting embodiment, the mounting assembly 90 includes a mounting bracket 92 and an adapter 94 connected to the mounting bracket 92. At least one of the mounting bracket 92 and the adapter 94 may have a clevis-type configuration. As shown, the mounting bracket 92 has a base 96 and a substantially parallel first arm 98 and a second arm 100 protruding upwardly from an upper surface of the base 96. Although each of the arms 98, 100 of the mounting bracket is illustrated as a clevis assembly having two parallel portions and a space therebetween for receiving a portion of the adapter 94, embodiments where the arms are a protrusion are also within the scope of the disclosure.

In the illustrated non-limiting embodiment, the adapter 94 of the mounting assembly 90 additionally includes a body 102 and a first connector arm 104 and a second connector arm 106 extending from the body 102, respectively. As shown, each connector arm 104, 106 is positionable directly adjacent one of the first arm 98 and the second arm 100 of the mounting bracket 92, and in some embodiments in the clearance between the parallel arms of each arm. However, it should be understood that embodiments where the adapter 94 does not include a pair of connector arms is also within the scope of the disclosure. In such embodiments, the body 102 itself may directly couple to the arms 98, 100 of the mounting bracket 92.

Each pair of arms 98, 104 and 100, 106 may be rotatably connected via a fastener. Although a separate fastener is illustrated as being used to couple each arm 98, 100 to a corresponding connector arm 104, 106, embodiments where a single fastener extends through both pairs of arms is also within the scope of the disclosure. As shown, the connection between each of the connector arms 104, 106 of the adapter and a respective arm 98, 100 of the mounting bracket 92 is coaxial, such that the adapter rotates about a first axis R1 relative to the mounting bracket 92. In the illustrated non-limiting embodiment, the first axis R1 is oriented generally parallel to at least one of the first and second lateral edges 62, 64 of the body 60 of the cleaning element 24.

In some embodiments, the cleaning element 24 is also movable, for example, rotatable relative to the handle 22 about a second axis R2. In the illustrated non-limiting embodiment, the second axis R2 is arranged generally perpendicular or orthogonal to the first axis R1. However, embodiments where the second axis R2 is arranged at another angle relative to the first axis R1 are also contemplated herein. To couple the cleaning element 24 to the handle 22, the body 102 of the adapter 94 is inserted into the clearance 53 formed between the upper wall 48 and the lower wall 50 of the connector portion 42. As shown, the body 102 of the adapter 94 has a through hole 110 formed therein, and when installed within the clearance 53, the fastener 58 is configured to extend through the through hole 110. As shown, the through hole is arranged at a generally central portion of the adapter body 102 such that part of the body 102 is arranged between the fastener 58 and the rear wall 46. When the adapter body is installed within the clearance and attached to the connector portion 42 via the fastener 58, the body 102, and therefore the cleaning element 24 coupled to the adapter body 102 via the mounting bracket 92, is configured to rotate relative to the fastener 58. Accordingly, in an embodiment, the axis of the fastener 58 connecting the mounting assembly 90 to the connector portion 42 of the handle 22 defines the second axis R2 of rotation of the cleaning element 24.

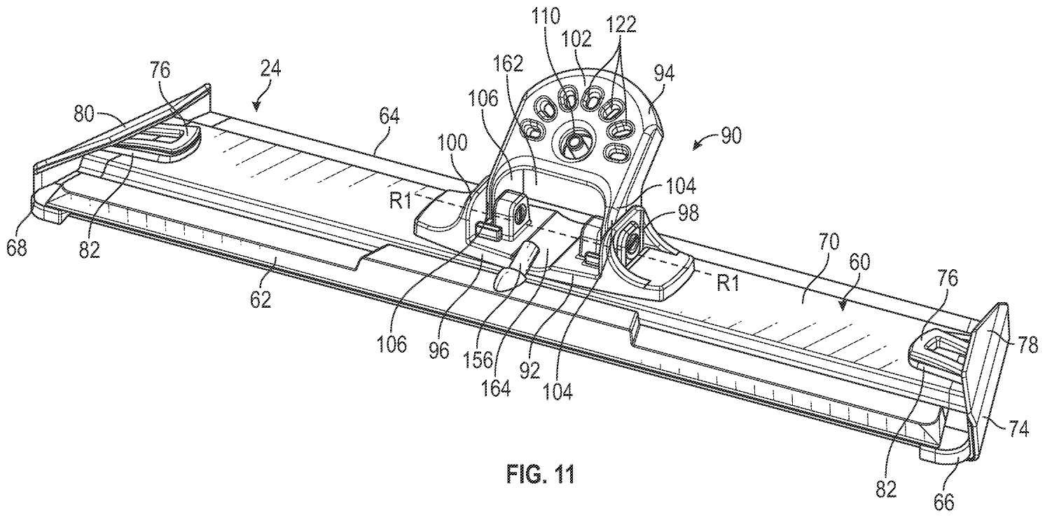

The handle 22 may include a locking mechanism 120 operable to selectively lock or retain the adapter in one of the plurality of positions along the path of movement about the second axis R2. As best shown in FIG. 11, in an embodiment, the body 102 of the adapter 94 includes a plurality of openings 122 radially spaced about a portion of the periphery of the through hole 110. Each opening 122 may be associated with a different position of the plurality of positions. In the illustrated non-limiting embodiment, the openings 122 are equidistantly spaced about 180 degrees of the circumference of the through hole. Accordingly, in an embodiment, the plurality of openings 122 represent when the front or rear lateral edges 62, 64 of the cleaning head may be arranged at 0°, 30°, 60°, 90°, 120°, 150°, and 180° relative to the longitudinal axis X of the handle 22, respectively. It should be understood that in other embodiments, the plurality of openings 122 may extend about less than 180 degrees, such as about 120 degrees or 90 degrees for example, or alternatively, may extend about greater than 180 degrees of the periphery of the through hole 110.

An engagement mechanism 123 may be movably mounted to the handle 22, such as to the connector portion 42 for example. Although the engagement mechanism 123 is illustrated as being pivotable about an axis between a first unlocked position and a second locked position, it should be understood that embodiments where the engagement mechanism 123 may be configured to move in another manner, such as rotating about an axis having another orientation or translating relative to the handle 22 for example, are also within the scope of the disclosure. In the illustrated non-limiting embodiment, the engagement mechanism 123 includes a button 124 arranged at a first side of the connector portion 42. A user may apply force to the button 124 to toggle or move the engagement mechanism 123 between the unlocked and locked positions. For example, a user may apply a force to a first end 126 of the button 124 to move the engagement mechanism 123 into a locked position thereby securing the adapter 94 in a desired position and restricting movement of the adapter 94 relative to the handle 22 and a user may apply a force to a second end 128 of the button 124 to move the engagement mechanism 123 into an unlocked position thereby releasing the adapter 94 and allowing movement relative to the handle 22.

The engagement mechanism 123 additionally includes one or more engagement features 130 (see FIG. 5) arranged at a second side of the connector portion 42, facing toward the body 102 of the adapter 94. In the illustrated non-limiting embodiment, the at least one engagement feature 130 includes a post or other protrusion. The engagement feature 130 may be sized for receipt within each of the plurality of openings 122. In an embodiment, when the engagement mechanism 123 is in the unlocked position, the engagement feature 130 is separated or remote from the openings 122. In an embodiment, when the engagement mechanism 123 is in the unlocked position, the engagement feature 130 is located generally remotely from the clearance 53 between the upper wall 48 and the lower wall 50. In this position, the adapter 94 may be freely rotatable about axis R2. Once rotated about axis R2 to a desired position, a user may apply a force to the first end 126 of the button 124 of the engagement mechanism 123 to move the engagement mechanism 123 to the locked position. In the locked position, at least a portion of the engagement feature 130 may be arranged within a corresponding opening 122. The diameter of the engagement feature 130 may be generally equal to or slightly smaller than the diameter of the openings 122. As a result of this engagement, rotation of the adapter 94 about the axis R2 may be restricted in both a first direction and a second direction opposite the first direction. It should be understood that the locking mechanism 120 illustrated and described herein is intended as an example only and that embodiments including another type of locking mechanism operable to selectively lock the adapter 94 at various positions rotated about axis R2 relative to the handle 22 are within the scope of the disclosure.

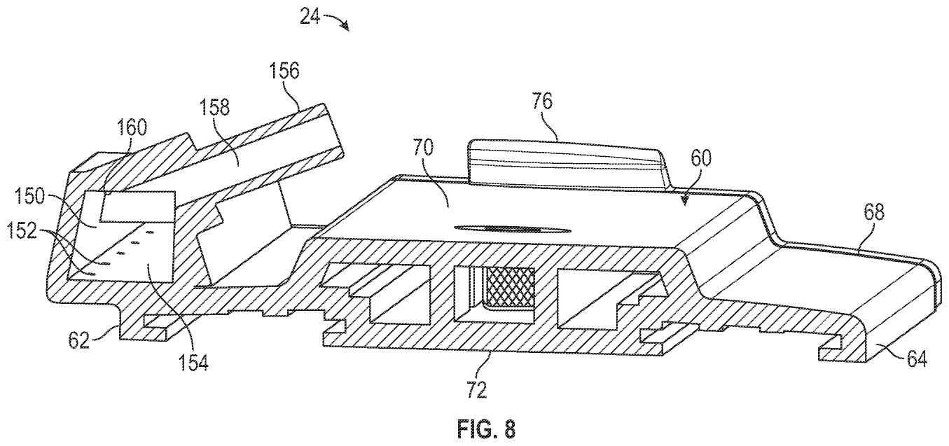

In an embodiment, the cleaning device 20 may be suitable for use with a fluid, such as a cleaning solution or water for example. A flexible conduit 140 may be coupled at a first end 142 to a source of fluid, illustrated schematically at 144 in FIG. 3, such as a tank or pouch for example. A second opposite end 146 of the flexible conduit 140 may be connectable to the cleaning element 24 such that the fluid may be expelled from a portion of the cleaning element 24. With reference to the cross-sectional view of the cleaning element 24 shown in FIG. 8, an enclosed hollow internal cavity 150 may be arranged adjacent to the front lateral edge 62 of the body 60 of the cleaning element 24. In the illustrated non-limiting embodiment, the cavity 150 extends forward of the second surface 72 configured to receive the pad 74. The cavity 150 is illustrated as extending over the entirety or the substantial entirety of the front edge 62 of the body 60 of the cleaning element 24. However, embodiments where the cavity 150 extends over only a portion of the front edge 62 of the cleaning element 24 are also contemplated herein.

One or more ports or through holes 152 are formed at a bottom surface 154 of the cavity 150, such as in a portion set back from the second surface 72. An inlet 156 having a hollow channel 158 may be fluidly connected to the cavity 150. As shown, the inlet 156 extends from a portion of the cavity 150. In the illustrated non-limiting embodiment, the inlet 156 extends from an upper surface 160 of the cavity 150 at an angle, in a direction towards the mounting assembly 90. However, it should be understood that an inlet 156 arranged at another location or having another orientation is also within the scope of the disclosure. In an embodiment, fluid from the fluid source 144 may be provided to the at least one port 152 via gravity. Alternatively, or in addition, a pump 145 may be operable to move fluid from the fluid source to the cavity 150 of the cleaning element 24 such that the fluid may be expelled from the at least one port 152 as a spray having a desired pressure. The pump 145 may be a part of or connected to the inlet 156 or the source of fluid 144 or may be located along the flexible conduit 140.

In an embodiment, best shown in FIG. 3, the flexible conduit 140 may extend through the opening 34 at the first end 36 and into the hollow interior 32 of the handle body 30. This configuration may protect the flexible conduit 140 and/or prevent the flexible conduit from becoming tangled or caught. Further, an opening (not shown) may be formed in the rear wall 46 of the connector portion 42 and the second end 146 of the conduit 140 may extend there through, towards the cleaning element 24. By forming the interface between the mounting bracket 92 and the adapter 94 of the mounting assembly 90 as a clevis-type configuration, a gap 162 may be formed between the pairs of arms 98, 104 and 100, 106, respectively. The second end 146 of the flexible conduit 140 may extend through this gap 162 and couple to the inlet 156. However, in an embodiment, best shown in FIG. 11, a groove 164 may be formed in the base 96 of the mounting bracket 92 to provide additional clearance for the flexible conduit 140. In an embodiment, at least a portion of the inlet 156 may be insertable into the second end 146 of the flexible conduit 140 to fluidly couple the conduit 140 to the cavity 150 of the cleaning element 24. However, alternate embodiments where the second end 146 of the flexible conduit 140 may be insertable into the channel 158 of the inlet 156 are also contemplated herein, for example, the flexible conduit 140 may be above the adapter 94 or to the side of the mounting assembly 90. It is further contemplated that the inlet 156 may be located at any position along the cavity 150.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A cleaning device comprising:
a handle having a longitudinal axis;
a cleaning element movably coupled to the handle; and
a flexible conduit fluidly connectable to the cleaning element, the flexible conduit being positionable within an interior of the handle;
wherein the cleaning element is movable relative to the handle about a first axis and a second axis when the flexible conduit is fluidly coupled to the cleaning element, both the first axis and the second axis being arranged at an angle relative to the longitudinal axis.

2. The cleaning device of claim 1, wherein an orientation of the cleaning element remains constant relative to the longitudinal axis as the cleaning element rotates about the first axis.

3. The cleaning device of claim 1, wherein the second axis is orthogonal to the first axis.

4. The cleaning device of claim 1, further comprising a mounting assembly coupling the cleaning element to the handle.

5. The cleaning device of claim 4, wherein the mounting assembly further comprises:
a mounting bracket; and
an adapter connected to the mounting bracket, wherein the mounting bracket is rotatable relative to the adapter about the first axis.

6. The cleaning device of claim 5, wherein at least one of the mounting bracket and the adapter has a clevis-type configuration.

7. The cleaning device of claim 5, wherein the adapter is positionable at a plurality of positions relative to the handle, the adapter being rotatable relative to the handle about the second axis.

8. The cleaning device of claim 7, further comprising a locking mechanism operable to retain the adapter in one of the plurality of positions.

9. The cleaning device of claim 8, wherein the locking mechanism further comprises an engagement mechanism movable between an unlocked position and a locked position, the adapter being movable between the plurality of positions when the engagement mechanism is in the unlocked position, and the adapter being restricted from moving between the plurality of positions when the engagement mechanism is in the locked position.

10. The cleaning device of claim 9, wherein the adapter further comprises a plurality of radially spaced openings and in the locked position, a portion of the engagement mechanism is positionable within one of the plurality of radially spaced openings.

11. The cleaning device of claim 1, wherein the cleaning element further comprises:
a body having a front lateral edge and a bottom surface; and
an internal cavity arranged adjacent to the front lateral edge, the flexible conduit being fluidly coupled to the internal cavity.

12. The cleaning device of claim 11, wherein the internal cavity extends forward of the bottom surface.

13. The cleaning device of claim 11, wherein one or more ports are formed on a bottom of the internal cavity.

14. The cleaning device of claim 11, further comprising a fluid source fluidly connected to a flexible conduit.

15. The cleaning device of claim 14, further comprising a pump operable to move fluid from the fluid source to the internal cavity.

16. The cleaning device of claim 1, further comprising a pad overlapping a bottom surface of the cleaning element.

17. The cleaning device of claim 16, wherein the pad is configured to wrap about at least one side of the cleaning element.

18. The cleaning device of claim 16, wherein the cleaning element further comprises a coupling mechanism and the pad further comprises a member removably connectable to the coupling mechanism.

19. A cleaning device comprising:
a cleaning element having a body with a front lateral edge and an internal cavity arranged adjacent to the front lateral edge;
a handle having a longitudinal axis movably coupled to the cleaning element by a mounting assembly, the mounting assembly having a mounting bracket and an adapter connected to the mounting bracket, the adapter being positionable at a plurality of positions relative to the handle;
a locking mechanism movable between an unlocked position and a locked position, and operable to retain the adapter in one of the plurality of positions;
a flexible conduit fluidly connected to a fluid source and the internal cavity, the flexible conduit being positionable within an interior of the handle;
a pump operable to move fluid from the fluid source to the internal cavity;
wherein the cleaning element is movable relative to the handle about a first axis and a second axis orthogonal to the first axis, both the first axis and the second axis being arranged at an angle relative to the longitudinal axis;
wherein an orientation of the cleaning element remains constant relative to the longitudinal axis as the cleaning element rotates about the first axis;
wherein the adapter is movable between the plurality of positions when the locking mechanism is in the unlocked position, and the adapter is restricted from moving between the plurality of positions when the locking mechanism is in the locked position.
